(19) United States
(12) Patent Application Publication
(10) Pub. No.: US 2008/0015780 A1
(43) Pub. Date: Jan. 17, 2008

(54) NON-LINEAR INVERSION TECHNIQUE FOR INTERPRETATION OF GEOPHYSICAL DATA USING ANALYTICALLY COMPUTED FIRST AND SECOND ORDER DERIVATIVES

(75) Inventors: Vijay Prasad Dimri, Andhra Pradesh (IN); Nimisha Vedanti, Andhra Pradesh (IN)

Correspondence Address: SEED INTELLECTUAL PROPERTY LAW GROUP PLLC, 701 FIFTH AVE, SUITE 5400, SEATTLE, WA, 98104, US

(73) Assignee: COUNCIL OF SCIENTIFIC AND INDUSTRIAL RESEARCH, New Delhi (IN)

(21) Appl. No.: 11/693,468

(22) Filed: Mar. 29, 2007

(30) Foreign Application Priority Data
Mar. 30, 2006 (IN) 0887/DEL/2006

(51) Int. Cl. G01V 3/38

(52) U.S. Cl. 702/11

(57) ABSTRACT

In general all the geophysical data sets are non-linear in nature and should be tackled in non-linear manner in order to preserve the subtle information, contained in the data. It was customary to linearize non-linear problems for mathematical simplicity and to avoid tedious computations. A method solves a non-linear inversion problem in non-linear manner and avoids cumbersome mathematical computations without losing any information contained in the data. The efficacy is demonstrated on synthetic and field resistivity data, but it can be used for non-linear inversion of any geophysical data, as the general approach of the geophysical inversion is same for any data set.

### BACKGROUND OF THE INVENTION

1. Field of the Invention

The present invention relates to an efficient non-linear inversion technique for interpretation of geophysical data using analytically computed first and second order derivatives.

The invention has a wide range of applications in exploration geophysics i.e. for interpretation of geophysical data to delineate groundwater zones, mineral deposits, geothermal reservoir and subsurface mapping, which in turn can be useful for hydrocarbon exploration. The invention presents an innovative inversion scheme, which can be used to interpret various geophysical data in absence of any prior information. The said inversion technique has been applied to interpret 1D resistivity sounding data.

2. Description of the Related Art

In geophysical inversion first a model of subsurface is assumed then the theoretical geophysical response over the model is computed and it is compared with the observed data. This process is repeated for various models until there is minimum difference between the computed and observed response. Various inversion schemes have been designed on the basis of relationships between a small perturbation of the model and its effects on the observations, which are dealt in detail by Dimri V. P. in the book entitled ‘Deconvolution and Inverse Theory’ published by Elsevier science publishers in 1992. General approach of inversion of any geophysical data is same. In case of resistivity inversion a guessed model for resistivity and thickness of different layers is assumed and its theoretical response is computed. The computed results are then compared with the observed apparent resistivity data. The process is repeated iteratively till the difference between them is minimum. The theoretical apparent resistivity values are computed for a guessed model, with the use of linear filter described in detail by Ghosh, D. P. in his Ph.D. thesis, ‘The Application Of Linear Filter Theory To The Direct Interpretation Of Geological Resistivity Measurements’ Delft, Netherlands, 1970. It is observed that generally the change in model space and corresponding change in data space are non-linearly related to each other. The gradient methods to deal with this non-linear problem involve tedious and time consuming mathematics of Hessian matrix consisting of second order derivatives terms hence, the commonly used methods for the inversion of resistivity data are ridge regression and Occam's inversion, which solve the non-linear problem in linear fashion.

The ridge regression method was proposed in 1970 and was applied to various geophysical data sets. References may be made to Marquardt, D. W. “An Algorithm for Least Square Estimation of Non-Linear Parameters,” J. Soc. Indust. App. Math., 11, 431-441, 1963; Marquardt, D. W., “Generalized Inverse, Ridge Regression, Biased Linear Estimation and Non-Linear Estimation,” Technometrics, 12, 591-612, 1970; Horel, A. E. and Kennard, R. W., “Ridge Regression: Biased Estimation for Non-Orthogonal Problems,” Technometrics, 12, 55-67, 1970; Horel, A. E. and Kennard, R. W., “Applications To Non-Orthogonal Problems,” Technometrics, 12, 69-82, 1970; and Parker, R. L., “The Inverse Problems of Resistivity Sounding,” Geophysics, 49, 2143-2158, 1984.

Inman, J. R., was first to use the ridge regression method for inversion of resistivity data to overcome the problem with small eigenvalues in Inman, J. R., “Resistivity Inversion With Ridge Regression,” Geophysics, 40, 798-817, 1975. In this method the small eigenvalues encountered are increased by a factor known as damping parameter, where choice of damping parameter is responsible for the stability of the inversion. The method is also known as damped least square inversion where the non-linear problem is linearized and it converges only when initial guess is close to the solution.

To overcome the problems associated with gradient methods involving difficulties associated with computation of second order derivatives, Occam's inversion method was introduced by Constable, S. C., Parker R. L. and Constable, C. G., in “Occam's Inversion: A Practical Algorithm for Generating Smooth Models from Electromagnetic Sounding Data,” Geophysics, 52, 289-300, 1987 to find the smoothest model that fits the magnetotelluric (MT) and Schlumberger geoelectric sounding data. References may be made to Constable et al., 1987; deGroot-Hedlin, C. and Constable, S., “Occam's Inversion to Generate Smooth Two-Dimensional Models from Magnetotelluric Data,” Geophysics, 55, 1613-1624, 1990; LaBrecque et al, “The Effects of Noise on Occam's Inversion of Resistivity Tomography Data,” Geophysics 61, 538-548, 1996; S. Weerachai, and E. Gary-D, “An Efficient Data Space Occam's Inversion for Mt and Mv Data: EOS,” Transactions, American Geophysical Union. 77(46) Suppl., p. 156, 1996; and Wei-Qian, et al., “Inversion of Airborne Electromagnetic Data Using an Occam Technique to Resolve a Variable Number of Layers,” Proceedings of the Symposium on the Application of Geophysics to Environmental and Engineering Problems (SAGEEP), 735-739, 1997, where in a highly nonlinear resistivity problem is framed in a linear fashion. In order to stabilize the solution the damping parameter of the ridge regression method remains the part of the Occam's inversion. The parameterization is carried out in terms of its first and second derivative with depth and minimum norm solution provides the smoothest possible model.

However the drawbacks of this technique are:
For mathematical simplicity an alternative way of minimization was proposed to avoid computation of second order derivatives carrying useful curvature information of the objective function to be minimized; and
Convergence in this technique is highly dependent upon the choice of damping parameter or Lagrange's parameter.

For practical purposes the Occam's iteration steps are given as:
δᵢ=−[∂^{T}∂+μ⁻¹{WG(x)^{T}WG(x)}]⁻¹[∂^{T}∂ₓ−μ⁻¹WG(x)^{T}WΔΘ(x)]ₓ₌ₓ_{ᵢ}

where ‘i’ stands for iteration, μ is Lagrange's parameter account for smoothness, W is weighting matrix, G(x) is Jacobian of the functional to be minimized, ΔΘ(x) measures misfit.

∂ is a matrix given as

$$( \begin{matrix}0 & 0 & … & … & 0 \\ - 1 & 1 & … & … & 0 \\ 0 & - 1 & 1 & … & 0 \\ . & . & . & . & . \\ . & . & . & . & . \\ 0 & 0 & … & - 1 & 1\end{matrix} )$$

Thus due to lack of curvature information in the above inversion it yield unconverging results for μ<1 cases. Hence, there is a need to incorporate curvature information in terms of Hessian matrix. For values of μ>1 more weight goes to smoothness of model and for μ<1 more weight goes to the misfit function. Hence, there exists a problem owing to the choice of Lagrange's parameter ‘μ’ in Occam's inversion.

### BRIEF SUMMARY OF THE INVENTION

One embodiment of the invention provides a new and an efficient non-linear inversion technique for interpretation of geophysical data using analytically computed first and second order derivatives, which obviates the drawbacks as detailed above.

One embodiment of the present invention has direct implications in interpretation of resistivity data for the exploration of groundwater, mineral deposits, geothermal reservoir, subsurface mapping and delineation of fractures. The subsurface mapping in turn assists in oil exploration.

One embodiment of the present invention provides a stable technique that converges for Lagrange's parameter μ<1, for non-linear inversion of resistivity data. This is another addition to the existing method, which gives better convergence only for μ≧1.

One embodiment of the present invention incorporates the curvature information in terms of second order derivatives of the functional to be minimized to direct the minimization problem.

One embodiment of the present invention uses analytical expressions to compute the first order and second order derivatives of the objective functional to be minimized for accuracy and fast computations.

One embodiment of the present invention solves the non-linear optimization problem with global optimization strategy, which is independent of the initial model used.

### BRIEF DESCRIPTION OF THE SEVERAL VIEWS OF THE DRAWINGS

In the drawings accompanying this specification,

FIG. 1: (a-f) Represents convergence of the modified algorithm for different values of μ using observed apparent resistivity data along a profile in Southern Granulite Terrain (SGT), India. Solid lines denote the observed data, asterisks (*) denote the predicted values using the modified algorithm. The Starting model is a half space of 10⁵ ohm-m.

FIG. 2: Represents plot of iterations vs. RMS misfit for different values of μ using the same observed apparent resistivity data along a profile in Southern Granulite Terrain (SGT), India.

### DETAILED DESCRIPTION OF THE INVENTION

Accordingly one embodiment of the present invention provides a new and an efficient non-linear inversion technique for interpretation of geophysical data using analytically computed first and second order derivatives which comprises a new and stable method to solve non-linear inversion problem and obviates the cumbersome computations involved in the prior art solution of non-linear problems that requires tedious algebraic computation of second order derivative matrix known as Hessian matrix carrying very useful curvature information, which guarantees that the misfit function with the updated (new) point is less than misfit function with the current point.

In an embodiment of the present invention the non-linear inverse problem is solved by an efficient and stable inversion scheme wherein the problem in not linearized as is done in the prior art.

In another embodiment of the present invention the Hessian matrix elements comprising second order derivatives of the objective functional to be minimized are computed for two iterations and in further iterations this tedious piece of algebra is obviated using an algorithm described in details of the inventions without loosing the useful information contained in the Hessian terms.

In yet another embodiment of the invention the efficacy of the present invention has been shown over the previous techniques using 1-D DC resistivity data wherein it is shown that the new method proposed herewith is more robust and works efficiently for μ<1, whereas existing technique yields poor convergence in such cases as shown in example 2.

The non-linear resistivity inversion relates observed data and model parameters by equation:
Θ=g(x) (1)

Where,

Θ=(θ_{1,} . . . , θ_{N,}) is a vector representing observations at different half electrode separations in Schlumberger sounding, N is number of half electrode separations,

g(x)=(g₁(x), . . . , g_{N}(x)) represents predicted data at different half electrode separations, which are computed using model parameters.

The inverse problem is posed as an unconstrained optimization problem by the use of the Lagrange multiplier μ⁻¹, set forth to minimize misfitX=∥WΘ−Wg(x)∥, subject to the constraint that roughness R=∥∂x∥ is also minimized. Thus the functional to be minimized is given as:

$$U = \frac{1}{2} {‖ \partial x ‖}^{2} + \frac{1}{2 μ} \{ {( W ΔΘ ( x ) )}^{T} ( W ΔΘ ( x ) - {χ}_{*}^{2} ) \} \qquad ( 2 )$$

where δ is N×N matrix defined as:

$$\partial = ( \begin{matrix}0 & 0 & … & … & 0 \\ - 1 & 1 & … & … & 0 \\ 0 & - 1 & 1 & … & 0 \\ . & . & . & . & . \\ . & . & . & . & . \\ 0 & 0 & … & - 1 & 1\end{matrix} ) .$$

W is weighting matrix, χ* is acceptable misfit value and, ΔΘ(x)=WΘ−Wg(x). Expanding the functional in Taylor's series at x=xₖ (say) we get:

$$U ( {x}_{k} + δ , μ , Θ ) = U ( {x}_{k} , μ , Θ ) + {J}_{k}^{T} δ + \frac{1}{2} {δ}^{T} {Q}_{k} δ$$

where

$${J}_{k} = {∇}_{x} U = {\partial }^{T} \partial x - \frac{1}{μ} {( WG ( x ) )}^{T} W ΔΘ ( x ) and {Q}_{k} = {∇}_{x}^{2} U = \\ {\partial }^{T} \partial x - \frac{1}{μ} {∇}_{x} \{ {( WG ( x ) )}^{T} W ΔΘ ( x ) \} .$$

Using the identity:
∇ₓ{(WG(x))^{T}WΔΘ(x)}=(WH(x))^{T}WΔΘ(x)−(WG(x))^{T}WG(X)

the Qₖ becomes

$${Q}_{k} = {∇}_{x}^{2} U = {\partial }^{T} \partial x - \frac{1}{μ} \{ {( WG ( x ) )}^{T} WG ( x ) - {( WH ( x ) )}^{T} W ΔΘ ( x ) \}$$

where G(x) is Jacobian of g(x) and H(x) is Hessian of g(x).

If we define:

$${( WH )}^{T} W ΔΘ = {\sum }_{j} {WH}_{j} W {ΔΘ}_{j} = q$$

wherein Hⱼ is Hessian of g(x) evaluated at j^{th} data point and ΔΘⱼ=θⱼ−gⱼ(x), q is the nonlinear part of the Hessian.

Minimization of the functional (2) using Newton's method for i^{th} iteration step δᵢ yields:
δᵢ=−[∂^{T}∂+μ⁻¹{WG(x)^{T}WG(x)−q}]⁻¹*[∂^{T}∂ₓ−μ⁻¹WG(x)^{T}WΔΘ(x)]ₓ₌ₓ_{ᵢ}. (3)

Thus xᵢ₊₁=xᵢ+δᵢ forms the iterative basis to solve the optimization of functional (2). The equation (3) gives correction steps wherein we have incorporated second order derivative terms in form of ‘q’. By setting ‘q’ as a null matrix, the equation gives the model correction of the Occam's inversion technique. In our work we solve the problem iteratively using smoothed Gauss Newton method as follows:
xᵢ₊₁=xᵢ+αᵢδᵢ (4)

where αᵢ is the extra smoothing parameter which contains curvature information.

Following Chernoguz, N. G., A smoothed Newton-Guass method with application to bearing only position location: IEEE Trans. Signal Processing, 43(8), 2011-2013, 1995, we compute αᵢ as follows:

$${α}_{i} = \{ \begin{matrix}- {φ}^{′} ( 0 ) / {φ}^{′′} ( 0 ) if 0 < {α}_{i} \leq 1 \\ 1 otherwise\end{matrix} \qquad ( 5 )$$

where φ′(0) the is first order derivative and φ″(0) is the second order derivative of U (xᵢ+αᵢδᵢ,μ,Θ) that are computed as:
φ′(0)=δᵢ^{T}[∂ ∂xᵢ−μ⁻¹WG(xᵢ)^{T}WΔΘ(xᵢ)] and
φ″(0)=−δᵢ^{T}[∂ ∂xᵢ−μ⁻¹{WG(xᵢ)^{T}WΔΘ(xᵢ)−WH(xᵢ)^{T}WΔΘ(xᵢ)δᵢ}].

The computation of Hessian matrix is involved in each iteration if we use equation (4) directly. For very large data sets computation of the Hessian in each iteration becomes very tedious and time consuming. To minimize the tedious computations and at the same time to preserve the curvature information in the extra smoothing parameter a using the Hessian matrix we use following expression:
αᵢ=1−exp(−τi^{s}) (6)

where τ and s are positive scalar constants (s≧1), and are given as
τ=−ln(1−α₁),
s=log₂ [ln(1−α₂)/ln(1−α₁)]

In the said embodiment of the invention the equations (3, 4 and 5) are used for first two iterations to get the two consecutive values of ‘α’ say α₁ and α₂that are less than 1. In subsequent iterations, equation (6) can be applied directly to find the values of extra smoothing parameter ‘α’ to be used in correction steps of equation (4), and then the step size ‘δᵢ’ to be used in equation (4) can be computed as:
δᵢ=−[∂^{T}δ+μ⁻¹{WG(x)^{T}WG(x)}]⁻¹[∂^{T}∂ₓ−μ⁻¹WG(x)^{T}WΔΘ(x)]ₓ₌ₓ_{ᵢ}

by setting ‘q’ as a null matrix. This avoids computation of the tedious Hessian matrix in each iteration.

Generally, derivatives are calculated using finite-difference techniques that introduce many errors as mentioned by Gill, P. E., Murray, W. and Wright, M. H., in book ‘Practical Optimization’ published by Academic press in 1981. Errors associated with Hessian terms computation have a substantial effect on inversion algorithm. The use of analytical expressions instead of finite difference solves all the above problems. Hence, in the said embodiment, the Hessian terms are calculated analytically. In the said method initial model can be chosen at random as in the case of global optimization techniques.

Novelty of the said method lies in improved convergence of the inversion method for even μ<1 by inclusion of second order derivatives of the objective function to be minimized, which are computed analytically. These derivatives carry useful curvature information but involves tedious piece of algebra. Hence other inventive step in the said method is to avoid tedious second order derivative computations by incorporating expressions described in equation 6.

The following examples are given by way of illustration and therefore should not be construed to limit the scope of the present invention.

### EXAMPLE-1

Efficacy of the said embodiment in achieving good inverted model is shown here using synthetic model where the thickness of the layers is kept constant (=3.5 m) in order to have a smooth model. A forward response is computed using the synthetic model and that is inverted to get back the synthetic model. In the following table synthetic and inverted models are shown which shows that the error between the synthetic model and the model obtained after inversion using the said embodiment is very less.

| Synthetic Model Log₁₀ | Inverted Model Log₁₀ |
|---|---|
| Resistivity (ohm-m) | Resistivity (ohm-m) |
| 0.90 | 0.93 |
| 1.19 | 1.25 |
| 1.78 | 1.63 |
| 2.05 | 1.97 |
| 2.32 | 2.29 |
| 2.58 | 2.57 |

### EXAMPLE-2

This example demonstrates the comparative convergence of the said embodiment with the existing Occam's inversion. RMS misfit that measures the difference between the observed and computed response has been shown for different values of μ for same number of iterations. It is clear from this example that the RMS misfit for μ<1 is less in case of the said invention. The used synthetic model has been shown in example 1 for computation of following results.

| | | RMS Misfit | |
|---|---|---|---|
| | RMS Misfit | (Occam's Inversion | |
| μ | (Using embodiment) | Technique) | No. of Iterations |
| 1.5 | 0.0741 | 0.0553 | 5 |
| 1.0 | 0.0529 | 1.0576 | 5 |
| 0.75 | 0.0416 | 1.2609 | 5 |
| 0.5 | 0.0297 | 1.8186 | 5 |
| 0.25 | 0.0170 | 1.2405 | 6 |

### EXAMPLE-3

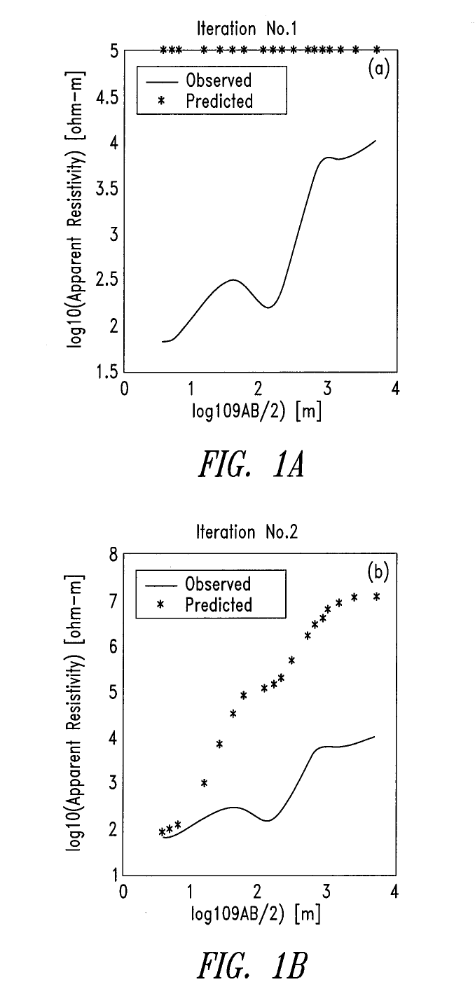

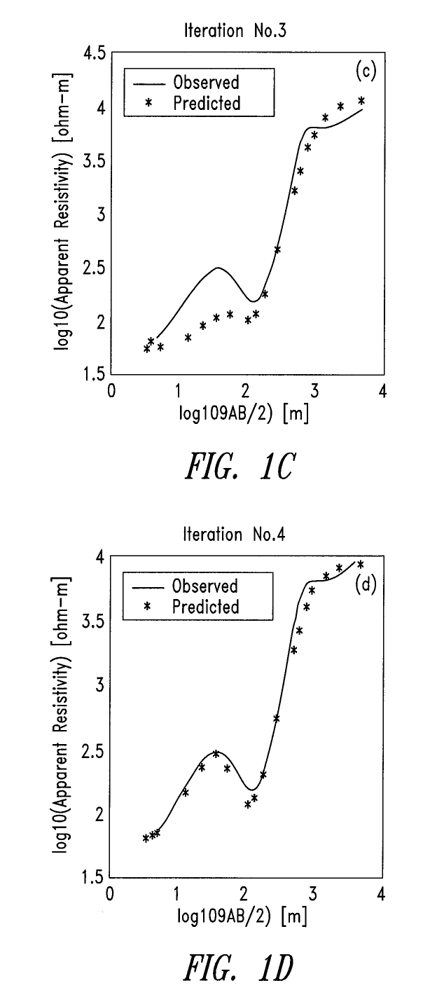

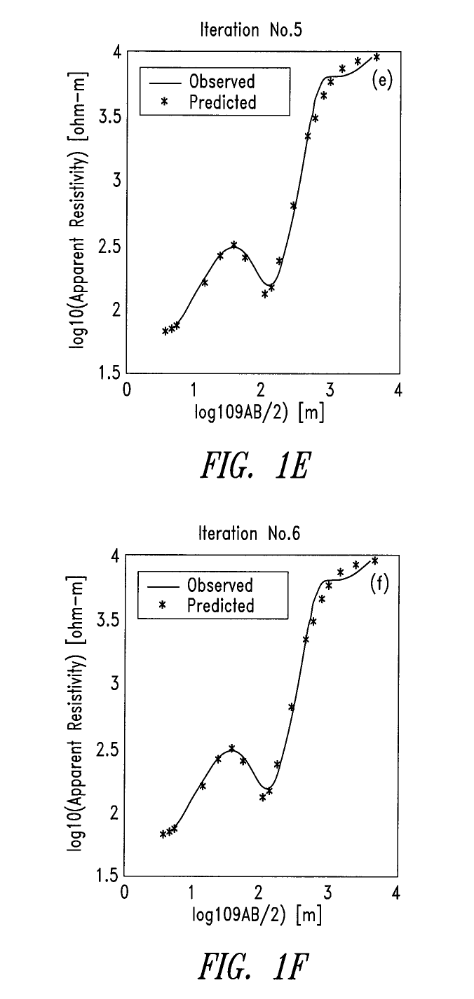

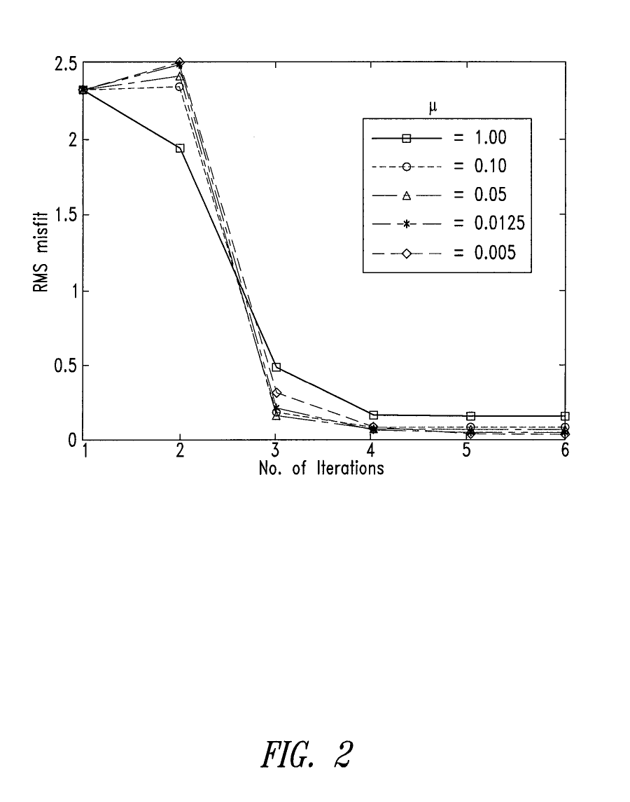

The said embodiment is used to interpret 1-D DC resistivity sounding data. The data from a geologically complex area of south India, Southern Granulite Terrain commonly known as SGT over a 10 km long profile located at 11°34′54″ N, 78°3′18″ E is used. The area represents a field example to demonstrate a wider applicability of the technique for any geological formation favorable for hydrocarbon, mineral deposit, groundwater geothermal reservoir etc. The convergence of the embodiment has been shown in FIG. 1(a-f) for different values of μ. The assumed starting model is a half space of 10⁵ ohm-m, which is far from the observed one. The method searches for the lowest misfit until it becomes constant with further iterations as shown in FIG. 2.

It is clear from above examples that the said embodiment is very efficient, robust and simple to be used for the inversion of geophysical data. The method obviates the need to linearize a nonlinear problem to simplify the problem and in general converges within 5 to 6 iterations. The improved convergence of the inversion method for even μ<1 is achieved by including second order derivatives of the objective function to be minimized, which are computed analytically. Efficacy of the said embodiment is demonstrated with synthetic and real examples. For μ<1, the said invention gives less RMS error as compared to Occam's as the number of iteration increases. In the said embodiment we choose initial model at random as in the case of global optimization techniques. The said embodiment can be applied to any non-linear geophysical data set in similar manner as demonstrated for resistivity data. The technique can be extended to 2-D inversion in similar way.

The said non-linear inversion technique can be used for interpretation of geophysical data to delineate the groundwater zones, exploration of minerals, oil and geothermal reservoir and to map the subsurface structures.

Some advantages are:

1. To provide an efficient and stable non-linear inversion technique for interpretation of the geophysical data.

2. A technique that can be used to delineate the groundwater zones, exploration of minerals, oil and geothermal reservoir and to map subsurface structures.

3. To achieve least RMS misfit as well as a good inverted model in order to delineate the subtle features from given observed data set.

4. To solve the non-linear optimization problem in non-linear manner with global optimization strategy, which is independent of the initial model used.

5. To preserve the curvature information during the optimization in form of Hessian matrix whose elements are computed accurately using analytical expressions and at the same time to reduce the tedious calculations for fast convergence.

6. The errors associated with the first and second order derivative computations, which lead to instability during inversion, were minimized by using analytical expressions.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

We claim:

1. A method, comprising:
non-linearly inverting geophysical data using steps including analytically computing first and second order derivatives of the data, wherein computing the second order derivative includes algebraically computing the second order derivative wherein a misfit function for a current data point is less than a misfit function for an immediately previous point.

2. A method as claimed in claim 1 wherein non-linearly inverting geophysical data includes non-linearly inverting 1D DC resistivity data wherein a smooth model is assumed for subsurface resistivity variation.

3. A method as claimed in claim 2 wherein a resistivity transform for the smooth model is computed using a Pekeris recurrence relation.

4. A method as claimed in claim 1 wherein:
the first order and second order derivatives are computed analytically and are multiplied with filter coefficients to obtain theoretical apparent resistivity values;
a theoretical response is matched with an observed response, and a misfit between the responses is computed using a smoothed Gauss-Newton optimization;
a search is effected for Lagrange's parameter p to minimize the misfit;
wherein if in any two consecutive iteration values of a smoothing parameter ‘α’ in Gauss-Newton optimization are obtained such that the two consecutive iteration values are <1, then the second order derivative computation is bypassed and the value of α obtained by consecutive a values are used in iteration steps, otherwise α=1;
a least square difference between the observed and theoretical responses is minimized by incorporating curvature information in extra smoothing parameter and all the steps above are repeated until a desired RMS misfit is obtained.

5. A method as claimed in claim 4 wherein the search is effected by a Golden section search.

6. A method as claimed in claim 1 wherein 5 to 6 iterations are carried out and converged using global optimization.

7. A method as claimed in claim 1 wherein in the first and second order derivatives, associated errors that lead to instability during inversion are minimized by using algebraic expressions.

8. A method as claimed in claim 1 wherein computing the second order derivative includes incorporating curvature information in smoothed Gauss-Newton iteration steps.

9. A method as claimed in claim 1 wherein the non-linearly inverting steps relates observed resistivity data and model parameters and is solved by the equation
Θ=g(x)
where
Θ=(θ_{1,} . . . , θ_{N,}) is a vector representing observations at different half electrode separations in Schlumberger sounding, N being a number of half electrode separations,
g(x)=(g₁(x), . . . , g_{N}(x)) represents predicted data at different half electrode separations, which are computed using model parameters.

10. A Method as claimed in claim 1 wherein the non-linearly inverting step includes using a Lagrange multiplier μ⁻¹, set forth to minimize misfitX=∥WΘ−Wg(x)∥, subject to a constraint that roughness R=∥∂x∥ is also minimized, thereby an equation being minimized is:
$$U = \frac{1}{2} {‖ \partial x ‖}^{2} + \frac{1}{2 μ} \{ {( W ΔΘ ( x ) )}^{T} ( W ΔΘ ( x ) - {χ}_{*}^{2} ) \}$$
where ∂ is N×N matrix defined as:
$$\partial = ( \begin{matrix}0 & 0 & … & … & 0 \\ - 1 & 1 & … & … & 0 \\ 0 & - 1 & 1 & … & 0 \\ . & . & . & . & . \\ . & . & . & . & . \\ 0 & 0 & … & - 1 & 1\end{matrix} )$$
W is weighing matrix, χ* is acceptable misfit value and, ΔΘ(x)=WΘ−Wg(x).
